(19) United States
(12) Patent Application Publication
(10) Pub. No.: US 2024/0149353 A1
(43) Pub. Date: May 9, 2024

(54) SYSTEM AND METHOD FOR ADDITIVE MANUFACTURING

(71) Applicant: ULC Technologies LLC, Hauppauge, NY (US)

(72) Inventors: Aalap R. Shah, Princeton, NJ (US); Brendan Reilly, Bethpage, NY (US)

(21) Appl. No.: 18/501,726

(22) Filed: Nov. 3, 2023

Related U.S. Application Data
(60) Provisional application No. 63/382,424, filed on Nov. 4, 2022.

(51) Int. Cl. B22F 12/80; B22F 10/25; B22F 10/30; B22F 12/57; B33Y 10/00; B33Y 30/00; B33Y 50/02

(52) U.S. Cl. CPC B22F 12/80; B22F 10/25; B22F 10/30; B22F 12/57; B33Y 10/00; B33Y 30/00; B33Y 50/02

(57) ABSTRACT

A system and method for additive manufacturing are provided. The system for additive manufacturing can include a fabrication robot configured to perform a fabrication process within a pipe, and a support robot configured to support the fabrication robot. The fabrication process may include the fabrication robot depositing a material on the pipe, thus consuming material throughout the fabrication process. The support robot may traverse between an entrance of the pipe and the fabrication robot to obtain additional material and to refill the fabrication robot and the material is consumed. The support robot may further be configured to install and remove one or more tether management rings along bends within the pipe, such that the tether management rings can reduce drag caused by a tether of the fabrication robot.

### RELATED APPLICATIONS

This application claims priority to U.S. Provisional Patent Application No. 63/382,424 filed Nov. 4, 2022, the entire disclosure of which is incorporated herein by reference.

### ACKNOWLEDGMENT OF GOVERNMENT SUPPORT

This invention was made with government support under Contract No. DE-AR0001335 awarded by the Department of Energy, Office of Advanced Research Projects Agency-Energy (ARPA-E). The government has certain rights in this invention.

### FIELD OF THE INVENTION

This disclosure generally relates to additive manufacturing. More specifically, this disclosure relates to a method and a system for performing additive manufacturing for pipeline rehabilitation.

### BACKGROUND OF THE INVENTION

In various industries, pipes, pipelines, and other conduits may be used to transport goods and commodities. In some instances, a pipeline may be used to transport liquids, gases, or moveable solids over a long distance.

Pipelines carrying products such as natural gas, water, biofuels, or petroleum products degrade over time. Degradation may occur from external corrosion due to contact with soil or by internal corrosion due to gases and liquids, such as hydrogen sulfide, water, or carbon dioxide. Degradation may also be caused by forces such as earth settlement, heavy traffic, and other activities such as the installation of adjacent utilities.

Independent of the cause, various defects may form in the pipe or conduit surface over time, which results in wall loss, cracking, and dents. Increasing stresses in the pipe can further accelerate the rate of degradation, which may be further accentuated when high-pressure hydrogen is being transported in the pipe.

The pipeline industry is responsible for inspecting its pipes, and either rehabilitating or replacing pipes on an ongoing basis to ensure safe operation and to avoid incidents (such as pipe failures) that may be detrimental to people and property.

Pipeline rehabilitation may be performed in several ways. Repairs are typically performed by excavating around the pipe and manually installing external composite wraps, clamps, or reinforcing sleeves. Quite often, the pipe may be cut open, and repairs are installed using internal expanding sleeves.

Cured-In-Place Liners (CIPL) and Cured-In-Place Pipes (CIPP) are premanufactured products that may be sent to a job site from the factory and may be installed in the pipe using a moving platform in the pipe from an open trench. Specifically, technologies like CIPL and CIPP are limited in use because they can only travel a certain distance in the pipe with the limitations being the pipe or liner that has to be moved into the pipe, and the number and type of bends. In general, CIPL/CIPP are known to have a limitation of being used/performed in pipes that are only several hundred feet long.

Prior to rehabilitating the pipe, a visual and Non-Destructive Evaluation (NDE) is typically performed to understand the nature of the defects and the ability to even perform a rehabilitation process. Some pipes may not be suitable for rehabilitation and may have to be replaced. Current methods are incapable of performing continuous and custom fabrication in a pipe by transporting raw materials such as feedstock. Thus, there is a need for a rehabilitation method that is more efficient than the current methods.

In a robotic system, robots that need to be constantly powered or in constant communication with an above-ground operator typically employ a tether. Robots performing inspection or rehabilitation may also need a supply of cooling fluid, couplant fluid, sealant fluid, or gas. Such a tether connected to the robot provides drag forces that the robot must overcome using onboard motors as it moves through the pipe.

Pipeline robots employing tethers have difficulties navigating around bends in pipes. This is because once the robot navigates around the first bend, the tether will contact the bend as it is being pulled through the pipe. Once the robot goes through another bend, the drag forces are excessively high, which could prevent the robot from traveling further through the pipe. The force of a tether rubbing on an edge can also cause damage to the tether. Therefore, to operate in a distribution pipeline comprising multiple bends, another solution that allows the robot to negotiate numerous bends would be useful.

Another challenge associated with fabrication in a pipeline is that the amount of feedstock required may be immense, and so the robot performing the fabrication work cannot carry the full amount of feedstock material. Feedstock materials may not be able to be transported over a tether, especially when provided in powder form or when the feedstock is transported over long distances. In such situations, an alternate means to transport the powder from the pipe entrance to the robot performing fabrication is needed to keep the fabrication process continuous, or substantially continuous.

When a fabrication robot stops fabrication and travels to the pipe entrance to retrieve more feedstock material, it may be difficult to resume fabrication from the previous position since locating the last position requires a great deal of accuracy and precision. When operating in pipes during downtime, time is of the essence since a non-operational pipeline can mean that customers are experiencing outages. Thus, there is a need to minimize the back-and-forth travel of the fabrication robot to the pipe entrance and fabrication location to provide for quicker restoration of the pipe.

### BRIEF SUMMARY OF THE INVENTION

An aspect of this disclosure pertains to a method and system for performing additive manufacturing inside a pipeline or other substantially enclosed conduit. Such an additive layer is designed to increase or extend the pipe's useful life.

Some aspects of this disclosure solve the problem of both tether management and material transportation by using a dual robot system. By splitting the function of fabrication, tether management, and material transport between two or more robots, it may be possible to achieve a continuous manufacturing process, or substantially continuous manufacturing process in the pipeline. This alleviates the problems associated with large amounts of downtime and minimizes the chances of errors in fabrication. Tether management by a separate robot may enable the fabrication robot to travel through bends without significant drag forces. Thus, the robot can travel to difficult-to-reach locations in complex environments such as those in urban areas or under railways, roadways, or water crossings, or in natural gas or other pressurized or potentially hazardous environments.

A system for additive manufacturing is provided. The system may include a fabrication robot configured to fabricate an additive layer inside a pipe and a heater configured to heat a material used by the fabrication robot. The system also includes a support robot configured to transport the material used by the fabrication robot in manufacturing the additive layer to the fabrication robot, wherein the support robot is in communication with the fabrication robot. The system also includes at least one wheel for traversing the support robot through the pipe and a sensor configured to detect a distance between the support robot and the fabrication robot. The system further includes a first material storage compartment for storing the material used to fabricate the additive layer.

In some embodiments, the support robot is configured to refill the first material storage compartment of the fabrication robot. In some forms, the support robot is configured to travel between an entrance of the pipe and the fabrication robot. In some embodiments, the support robot is further configured to install a tether management ring within the pipe and the tether management ring is configured to support a tether coupled to the fabrication robot. The support robot is configured to install the tether management ring at a bend of the pipe. In some embodiments, the tether management ring further comprises a first configuration such that the tether management ring is retracted and a second configuration such that the tether management is expanded to about a surface of the pipe. In some forms, the at least one wheel is a telescopic wheel, and the telescopic wheel can be expanded when the support robot traverses through the pipe, and the telescopic wheel can be retracted when the support robot traverses through the tether management ring. Further, in some forms, the fabrication robot is modular and includes a plurality of fabrication robot modules, wherein the plurality of fabrication robot modules each comprises a first material storage compartment for storing the material used to fabricate the additive layer, and wherein a forwardmost fabrication robot module is coupled to a fabrication module configured to fabricate the additive layer.

A method for additive manufacturing within a pipe is provided, including the steps of providing a fabrication robot and a support robot within the pipe, wherein the fabrication robot and the support robot are in communication with one another. The fabrication robot comprises a material storage compartment for storing material used to fabricate an additive layer within the pipe. The method further includes determining a distance between the fabrication robot and the support robot with a sensor and using at least one wheel to traverse the support robot through the pipe. The method also includes fabricating the additive layer on an internal surface of the pipe via the fabrication robot. The method further includes determining a fill level of the material storage compartment by the fabrication robot and sending a fill level signal to the support robot when the fill level of the material storage compartment is below a threshold value. The support robot can fill the material storage compartment of the fabrication robot when the fill level is below the threshold value.

In some embodiments, the method also includes the step of the support robot traveling between a first location proximal to the fabrication robot to a second location proximal to an entrance of the pipe. In some forms, the method also includes the support robot receiving additional material for fabrication from the first location, the support robot traveling to the second location, and the support robot filling the material storage compartment of the fabrication robot with the additional material received. In some embodiments, the support robot installs a tether management ring, wherein the tether management ring is configured to support a tether of the fabrication robot. The method can further include, in some embodiments, retracting a telescopic wheel of the support robot to permit the support robot to travel past the tether management ring, and extending the telescopic wheel of the support robot after the support robot travels past the tether management ring. In some embodiments, the fabrication robot also heats the material used to fabricate the additive layer.

Another embodiment provides a system for additive manufacturing within a pipe. The system includes a fabrication robot configured to fabricate an additive layer inside the pipe and a support robot in communication with the fabrication robot. The support robot is configured to transport material used by the fabrication robot and install a tether management ring. The tether management ring can include a frame, at least one piston, a non-return valve, and a roller positioned on an inside edge of the frame. The roller is disposed in an angular orientation and at least partially covers an inner circumference of the pipe. The tether management ring is configured to support a tether coupled to the fabrication robot.

In some embodiments, the frame of the tether management ring is expandable to fit inside an inner circumference of a pipe. In some forms, the frame is provided in the form of multiple frame pieces connected to each other, and the roller is provided between two of the frame pieces. In some embodiments, the frame of the tether management ring is a single-piece construction. In some embodiments, the tether management ring further comprises a plurality of ring segments, wherein each of the plurality of ring segments comprises a ring segment body, a magnet, and the roller.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 illustrates an isometric view of a robotic system for additive manufacturing disposed in a pipeline according to an embodiment;

FIG. 2 illustrates an isometric view of a fabrication robot according to an embodiment;

FIG. 3 illustrates another isometric view of the fabrication robot of FIG. 2;

FIG. 4 illustrates a side isometric view of the fabrication robot of FIG. 2;

FIG. 5 illustrates another isometric view of the fabrication robot of FIG. 2;

FIG. 6 illustrates an isometric view of a support robot according to an embodiment;

FIG. 7 illustrates a side isometric view of the support robot of FIG. 6;

FIG. 8 illustrates a bottom plan view of the support robot of FIG. 6;

FIG. 9 illustrates a top plan view of the support robot of FIG. 6;

FIG. 10 illustrates a front elevational view of a module of the support robot of FIG. 6;

FIG. 11 illustrates a rear isometric view of a module of the support robot of FIG. 6, rendered at least partially transparently for clarity;

FIG. 12 illustrates an isometric view of a support robot installing a tether management ring in a pipeline according to an embodiment, the pipeline rendered at least partially transparently for clarity;

FIG. 13 illustrates an isometric view of a support robot traversing through a tether management ring disposed in a pipeline according to an embodiment, the pipeline rendered at least partially transparently for clarity;

FIG. 14 illustrates an isometric view of a robot installing a tether management ring in a pipeline according to another embodiment, the pipeline rendered at least partially transparently for clarity;

FIG. 15 illustrates an isometric view of a robot installing a tether management ring in a pipeline according to another embodiment, the pipeline rendered at least partially transparently for clarity;

FIG. 16A illustrates a front elevational view of a tether management ring in a collapsed configuration according to an embodiment;

FIG. 16B illustrates a front elevational view of the tether management ring of FIG. 16A in an expanded configuration;

FIG. 17 illustrates an isometric view of a tether management ring positioned in a pipeline according to another embodiment;

FIG. 18 illustrates an isometric view of a robot engaging with the tether management ring of FIG. 17;

FIG. 19 illustrates a block diagram of a circuit board according to an embodiment; and

FIG. 20 illustrates a process diagram of a system for additive manufacturing according to an embodiment.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not for limitation.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

While additive manufacturing does not exist today as a solution for internal natural gas pipeline rehabilitation, there may be many benefits of performing additive manufacturing in a pipe or other conduit.

Additive manufacturing provides a pipeline operator with the flexibility of deciding the approach for repairs on-the-fly. During visual and NDE inspection, pipe features may be uncovered that require a custom or additional repair solution. An example of such a scenario may be the existence of service connections that run from the main pipeline to a customer's home or building. If a defect or other issue is detected through video from an inspection robot, a coating may be applied without sealing up the connection. This process may eliminate the need to restore the service connection after post-coating restoration. Conventional methods such as liner installation may require the service connection to be found and restored using an additional process once the liner has been installed.

Another example of a situation in which the device and process disclosed herein may be utilized is when pipe diameters change due to pipe transitions or when steps in pipe diameter is present due to sleeves or misaligned pipe sections. This makes it challenging to install a pre-manufactured repair solution. In such instances, programming changes in the field may allow for the fabrication of a custom coating that follows the pipe configuration. A custom sleeve is a type of spot repair that can be fabricated with desired thickness or length as determined as soon as the inspection is completed. The sleeve may be manufactured with radiused edges that minimize gas flow losses and minimize the chance of tools such as pipeline pigs getting stuck.

Such advantages of additive manufacturing provide the ability to respond to different situations that arise when working in unconstrained environments when even pipeline owners cannot expect to know the condition of their pipes until a camera or a robot is sent into the pipes. An additive manufacturing method may also allow for corrections or modifications to be made to a repair during or after the repair has been made.

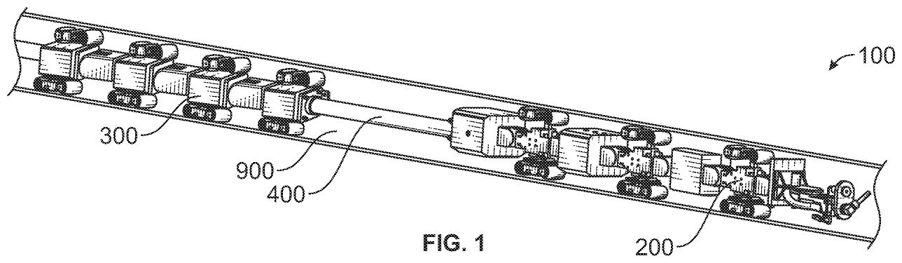

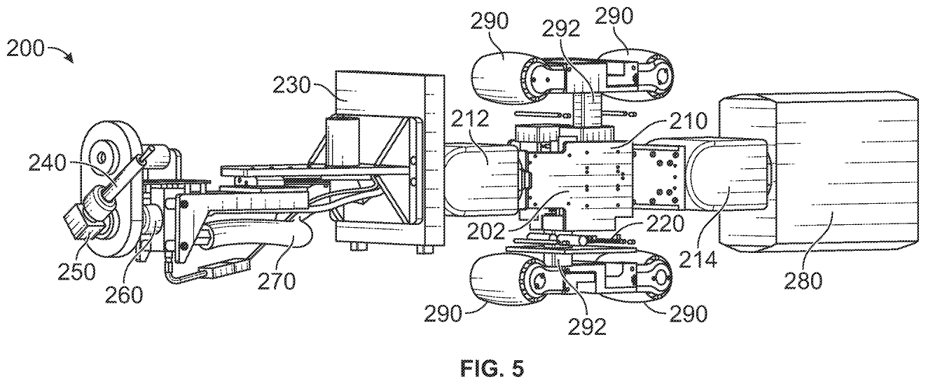

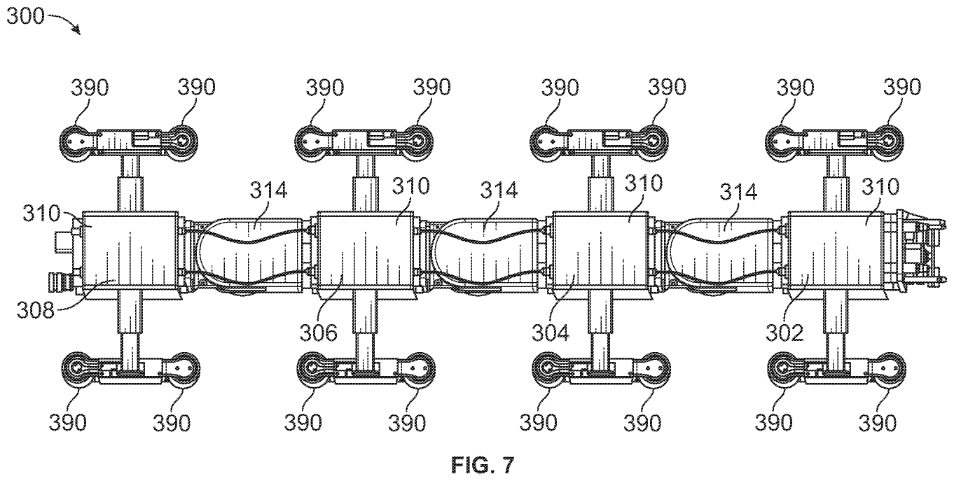

As shown in FIGS. 1-20, embodiments of this disclosure may include a system for additive manufacturing 100. Referring to FIG. 1, the additive manufacturing system 100 may include a fabrication robot 200 and a support robot 300 in communication with each other. The additive manufacturing system 100 is designed to be provided inside a conduit or pipe 900 of a pipeline. The fabrication robot 200 may be coupled to a tether 400, and the tether 400 may be provided through the support robot 300 as described in further detail below.

In some embodiments, the fabrication robot 200 is designed to perform additive manufacturing by depositing a coating onto an interior surface of the pipe 900. The fabrication robot 200 may add the coating to one or more portions of the pipe 900. The coating is designed to increase the strength of the pipe 900 by providing adequate bonding strength between the new coating and the pipe 900, which may serve as a repair or rehabilitation operation for cracks, surface deformities, and the like.

In further embodiments, the fabrication robot 200 may fabricate a new conduit or pipe within the pipe 900. The fabrication robot 200 may construct a new pipe that may be unbonded to the existing pipe wall of the pipe 900 and may serve as an independent structure that is nested or otherwise disposed adjacent the interior surface of the pipe 900.

In some embodiments, the fabrication robot 200 may be configured to perform cold spray additive manufacturing (CSAM). In such embodiments, the fabrication robot 200 may also be referred to as a “CSAM Robot”. However, as can be appreciated, the fabrication robot 200 may be configured to perform a number of fabrication processes within the pipe 900.

The fabrication robot 200 may be modular. In some embodiments, the fabrication robot 200 may include only one module. In other embodiments, the fabrication robot 200 may include multiple modules. For example, referring to FIGS. 1-3, the fabrication robot 200 may include a first fabrication robot module 202, a second fabrication robot module 204, and a third fabrication robot module 206. Though, more or less fabrication robot modules are also contemplated.

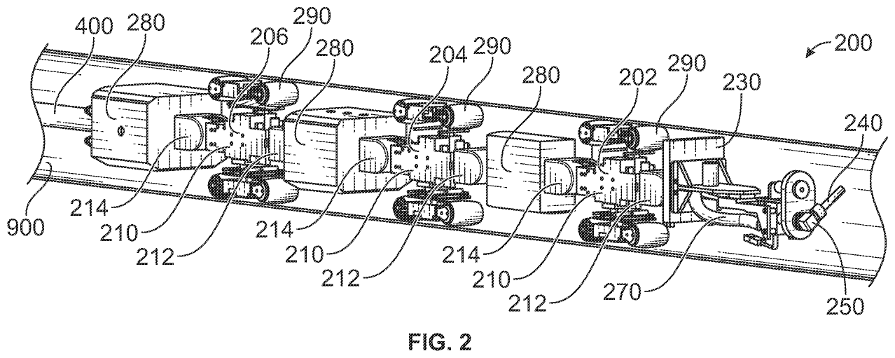

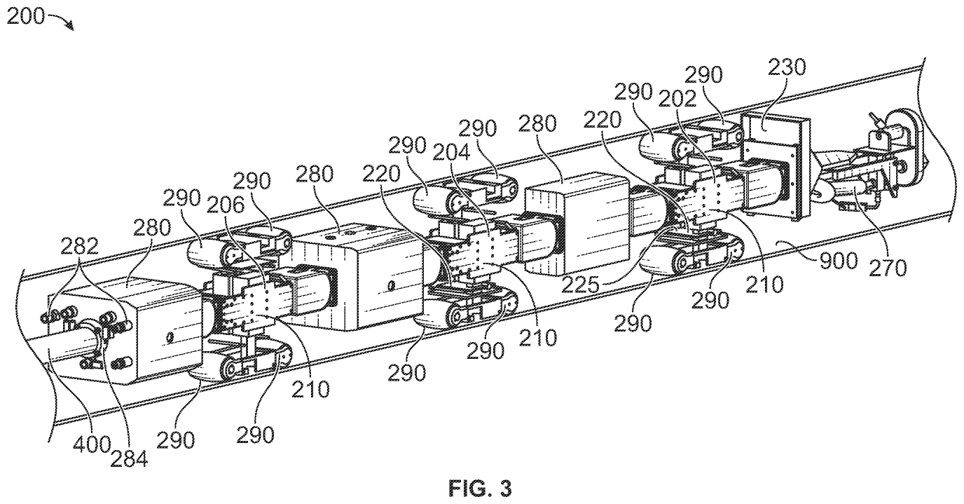

Referring to FIGS. 2-5, each module of the fabrication robot 200 may include a first robot body 210. The first robot body 210 may include a first circuit board 220 (see FIG. 3) that is configured to execute a program that controls the fabrication robot 200. The first circuit board 220 may include a processor coupled to a memory for executing the program stored on the memory. The first circuit board 220 may further include a communicator such as a receiver, a transmitter, and/or a transceiver configured to communicate with additional components of the additive manufacturing system 100, and/or with components external to the additive manufacturing system 100. Alternatively, one or more modules or portions of the fabrication robot 200 may be controlled remotely through a computer or a circuitry located external to the pipe 900.

The fabrication robot 200 may further include one or more sensor modules 225 configured to detect an environment of the fabrication robot 200. For example, the sensor module 225 may be a camera, a lidar, a proximity sensor, or other appropriate sensors. The sensor module 225 may be coupled to the first circuit board 220 to provide feedback to the processor. For example, the sensor module 225 may be configured to scan the pipe 900 to create a spray map. Moreover, the sensor module 225 may be configured to detect whether a path in front of the fabrication robot 200 is free of obstacles or the like.

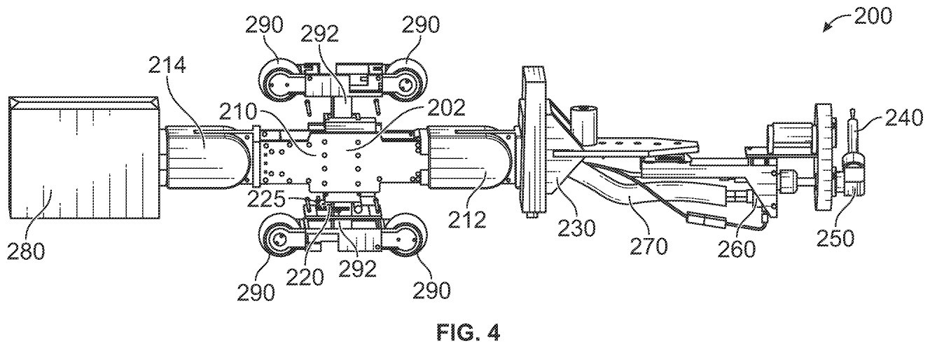

A forwardmost fabrication robot module (which corresponds to the first fabrication robot module 202 as shown in FIGS. 1-3) may be coupled to a fabrication module 230. The fabrication module 230 may include a nozzle 240 coupled to an applicator 250. As best seen in FIG. 4, the applicator 250 may further be coupled to a heater 260 and a feeder 270. The feeder 270 may be configured to feed feedstock material to the heater 260, which is designed to increase the temperature (e.g., warm) of the feedstock material for application by the applicator 250 and the nozzle 240. In some aspects, the heater 260 may be provided in the form of a drum that constantly rotates along with the applicator 250 and the nozzle 240 to allow for the feedstock material to be deposited in a continuous, spiral fashion forming the coating on the interior surface of the pipe.

The nozzle 240 may be designed to accept a high inlet pressure. In some embodiments, the nozzle 240 may have an inlet pressure between about 200 to about 1,400 pounds per square inch (psi), between about 400 to about 1,200 psi, between about 600 to about 1,000 psi, or around 800 psi. Certainly, other inlet pressures are also possible.

The heater 260 may be configured to warm the feedstock material, a gas, and/or other fluids or liquids, for application by the applicator 250 and the nozzle 240. In some embodiments, the heater 260 may heat the feedstock material to between about 100 to about 1,300 degrees Celsius (° C.), between about 300 to about 1,100° C., between about 500 to about 900° C., or around 700° C. Though as can be appreciated, other temperatures are also possible.

Depending on the implementation, the fabrication robot 200 may be configured to coat one or more sections of the pipe 900 in a continuous, or non-continuous manner with various thicknesses of the material. In some embodiments, the fabrication robot 200 may coat the pipe 900 to create an additive layer with less than about 0.1 inches (″) of material, less than about 0.2″ of material, less than about 0.3″ of material, less than about 0.4″ of material, or less than about 0.5″ of material. Certainly, other configurations may also be possible if dictated by the implementation.

In some embodiments, the fabrication robot 200 is designed to deposit the coating at a rate greater than about 10 grams (g) per minute, greater than about 25 g per minute, greater than about 50 g per minute, greater than about 75 g per minute, greater than about 100 g per minute, or greater than about 125 g per minute. Though other deposition rates are also contemplated.

In some embodiments, the fabrication robot 200 may have a material deposition efficiency of up to about 50%, up to about 60%, up to about 70%, up to about 75%, up to about 80%, up to about 90%, or about 100% efficiency. Though other deposition efficiencies are also contemplated.

Moreover, the fabrication robot 200 may be provided with a material flow rate of greater than about 250 standard liters per minute (SLPM), greater than about 500 SLPM, greater than about 750 SLPM, greater than about 1,000 SLPM, or greater than about 1,250 SLPM. Though other material flow rates are also contemplated.

In some embodiments, the nozzle 240 and the applicator 250 may be configured to apply the coating to the pipe 900 in a spiral or a corkscrew disposition pattern to minimize an application spray time and to maintain a continuous process, or substantially continuous process, without over or under-depositing material. In certain embodiments, the nozzle 240 may be moved axially and then rotated by a small increment followed by a return of the nozzle 240 to the original axial position. This operation may be performed until the full 360-degree circumference of the pipe 900 has been sprayed. In other embodiments, the nozzle 240 may be rotated 360-degree for continuous spraying.

One or more modules of the fabrication robot 200 may include a material storage compartment 280 that is designed to contain the feedstock material needed for the additive manufacturing process. The feeder 270 of the fabrication module 230 may be coupled to the material storage compartment 280 of the forwardmost fabrication robot module 202. Moreover, the material storage compartment 280 of each fabrication robot module may be connected, resulting in a larger combined storage space. In some instances, different substances (e.g., feedstocks) may be provided in each of the material storage compartments 280 of the respective fabrication robot module 202, 204, 206.

In some embodiments, each of the fabrication robot module 202, 204, and 206 may be configured to perform different functions. For example, the third fabrication robot module 206 may be configured to collect feedstock material and/or to return waste material from the support robot 300, while the first fabrication module 202 may be configured to perform the fabrication process in conjunction with the fabrication module 230. In further embodiments, a fabrication robot module closest to the tether 400 may be configured to retrieve wires from within the tether 400 to connect to components in subsequent fabrication module(s). Depending on the implementation, some or all of the fabrication robot modules may be configured to perform a same function, or the fabrication robot modules may each be configured to perform a different function.

Still referring to FIG. 4, each module of the fabrication robot 200 may also include one or more wheels 290 for traversing the pipe 900. The wheels 290 may be telescopically coupled to the first robot body 210 through a telescopic mechanism 292. The telescopic mechanism 292 may extend the wheels 290 outwardly toward an interior surface of the pipe 900 in a first configuration, allowing the wheels 290 to be in contact with the surface of the pipe 900. The telescopic mechanism 292 may also retract the wheels 290 inwardly toward the first robot body 210 in a second configuration, allowing the fabrication robot 200 to minimize its volumetric footprint and dimension while the wheels 290 are retracted.

Each module of the fabrication robot 200 may further include a first coupling 212 and a second coupling 214 protruding outwardly therefrom. In some embodiments, the first coupling 212 and/or the second coupling 214 may be provided in the form of a universal joint that may allow rotational and pinching motion at each joint. For the forwardmost fabrication robot module 202, the first coupling 212 may couple the first robot body 210 to the fabrication module 230. The second coupling 214 may couple the first robot body 210 to the material storage compartment 280.

In embodiments where multiple fabrication robot modules are used, additional fabrication robot modules (such as the second fabrication robot module 204 and the third fabrication robot module 206) may each be coupled to the material storage compartment 280 of the fabrication robot module adjacent to or in front of the respective fabrication robot module on a first end through the first coupling 212, and its own material storage compartment 280 on a second end through the second coupling 214.

Referring again to the example embodiments shown in FIGS. 2 and 3, the first coupling 212 of the first fabrication robot module 202 may be coupled to the fabrication module 230. The second coupling 214 of the first fabrication robot module 202 may be coupled to its own material storage compartment 280 (or a first material storage compartment). Therefrom, the first coupling 212 of the second fabrication robot module 204 may be coupled to the first material storage compartment 280 (i.e., the material storage compartment 280 of the first fabrication robot module 202), and the second coupling 214 of the second fabrication robot module 204 may be coupled to its own material storage compartment 280 (or a second material storage compartment). Likewise, the first coupling 212 of the third fabrication robot module 206 may be coupled to the second material storage compartment 280 (i.e., the material storage compartment 280 of the second fabrication robot module 204), and the second coupling 214 of the fabrication robot module 206 may be coupled to its own material storage compartment 280 (or a third material storage compartment), and so forth. Conduits or connections may be provided within the first coupling 212 and the second coupling 214, thus allowing material, power, and/or communication data or information to be provided from one fabrication robot module to another.

In embodiments where the fabrication robot 200 is configured for cold spray additive manufacturing in natural gas pipelines, the feedstock may be provided in the form of a metallic powder, such as stainless steel or mild steel, which may be used as materials deposited on a low-carbon pipe substrate. In such embodiments, a spot repair may be provided in the form of an internal sleeve that may be bonded to the pipe 900. By way of example, in such circumstances, a 10-foot-long sleeve in a 20″ diameter pipe of 0.1″ thickness would require approximately 102 pounds of feedstock powder.

Since the fabrication robot 200 may need to pass through bends within the pipe 900, which may be a 1-D swept or mitered bend, the size of the fabrication robot 200 may be restricted so as to allow the fabrication robot 200 to pass through the bends. This limits the volume available to store the powder on the fabrication robot 200 via the material storage compartments.

In some embodiments, around 20 pounds of the material may be stored on the fabrication robot 200 at a time which may be less than what is required to fabricate the full sleeve in the pipe 900. Thus, in some applications, there may be a need to replenish the powder in the material storage compartment(s) 280.

In some embodiments, the replenishment of material for the fabrication robot 200 may be performed by the support robot 300. The support robot 300 may be able to shuttle back and forth between the fabrication robot 200 and an entrance of the pipe 900, or other location of the material. The material storage compartment 280 may include one or more material ports 282 (see FIG. 3) that can be coupled with the support robot 300 to receive material from the support robot 300. In some embodiments, the material port 282 may be included only in the material storage compartment 280 of the rearmost fabrication robot module (which corresponds to the third fabrication robot module 206 as shown in FIGS. 1-3).

The fabrication robot 200 may further include a tether port 284 that may be coupled to the tether 400 to accept contents from the tether 400. For example, the tether port 284 may be able to accept fluids, gas, power, communication, or other contents or information through the tether 400 as applicable.

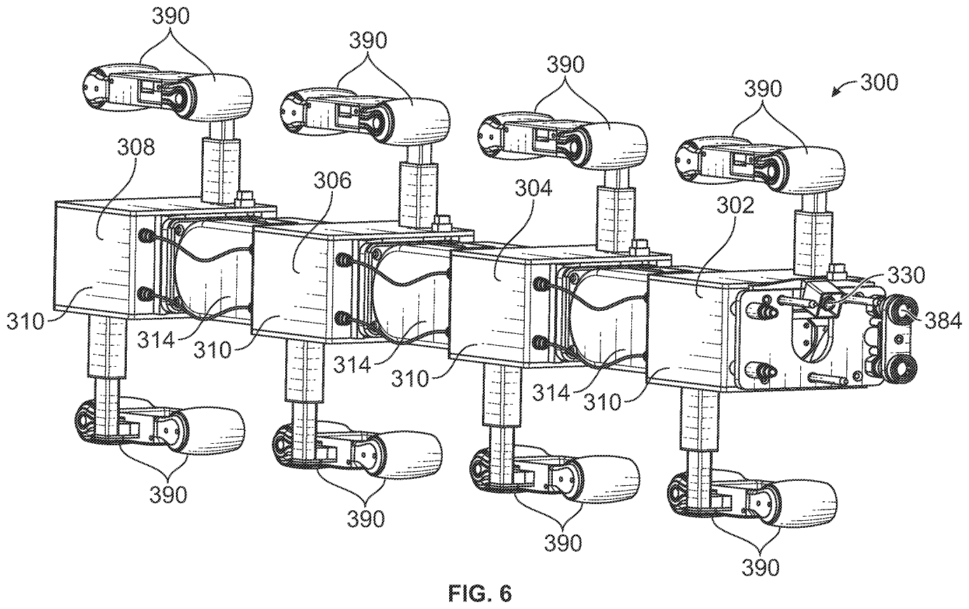

Referring to FIGS. 6-11, the support robot 300 is shown in more detail. Similar to the fabrication robot 200, the support robot 300 may be modular. The support robot 300 may include one support robot module, or the support robot 300 may include multiple support robot modules. As shown in FIGS. 1, and 6-9, the support robot 300 may be provided in the form of four support robot modules—namely, a first support robot module 302, a second support robot module 304, a third support robot module 306, and a fourth support robot module 308. However, more or less support robot modules are also contemplated.

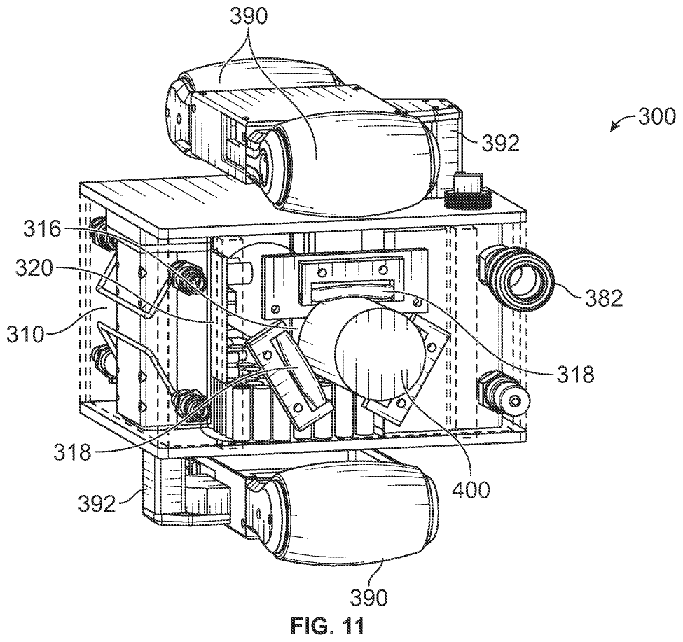

Each support robot module of the support robot 300 may include a second robot body 310. The second robot body 310 may include a second circuit board 320 (see FIG. 11) that is configured to execute a program that controls the support robot 300. The second circuit board 320 may include a processor coupled to a memory for executing the program stored on the memory. The second circuit board 320 may further include a communicator such as a receiver, a transmitter, and/or a transceiver configured to communicate with additional components of the additive manufacturing system 100, and/or with components external to the additive manufacturing system 100.

Each module of the support robot 300 may further include a first coupling 312 and a second coupling 314. Principally, the first coupling 312 of one support robot module may be coupled with the second coupling 314 of the next support robot module, thus connecting several support robot modules together. In some embodiments, the forwardmost support robot module 302 may have the first coupling 312 omitted. Similarly, the rearmost support robot module 308 may have the second coupling 314 omitted. Conduits or connections may be provided within the first coupling 312 and the second coupling 314, thus allowing material, power, and/or information to be transported from one support robot module to another.

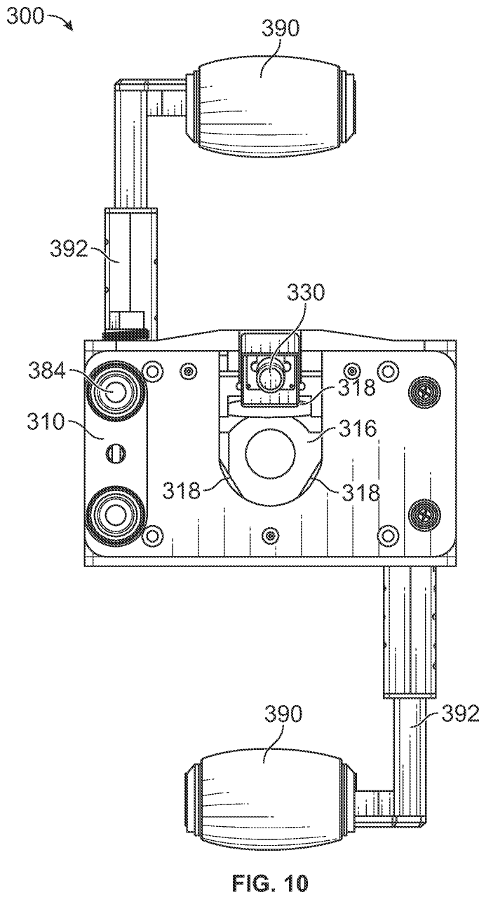

As shown in FIGS. 10 and 11, the second robot body 310 may include an opening 316 through which the tether 400 may pass. The opening 316 may allow the support robot 300 to traverse from the entrance of the pipe 900 to the fabrication robot 200 without the risk of driving over or colliding with the tether 400. As such, the support robot 300 may travel along the tether 400 of the fabrication robot 200, but the support robot 300 itself does not require a tether. In some embodiments, the support robot 300 may be battery-powered.

As best shown in FIG. 11, each support robot module of the support robot 300 may include one or more rollers 318 (three are shown in the example embodiment shown in FIG. 11, though more or fewer rollers 318 may also be used) positioned proximal to and circumscribing the opening 316. The rollers 318 may be in contact with the tether 400, thus allowing the tether 400 to pass through the opening 316 with minimal friction.

Each support robot module may also include one or more wheels 390 for traversing the pipe 900. The wheels 390 may be telescopically coupled to the second robot body 310 through a telescopic mechanism 392. The telescopic mechanism 392 may extend the wheels 390 outwardly toward an interior surface of the pipe 900 in a first configuration, allowing the wheels 390 to be in contact with the surface of the pipe 900. The telescopic mechanism 392 may also retract the wheels 390 inwardly toward the second robot body 310 in a second configuration, allowing the support robot 300 to minimize its volumetric footprint and dimension while the wheels 390 are retracted.

In some embodiments, the tether 400 may contain a high-pressure (such as approximately 1000 psi or greater at the hose inlet) gas (e.g., nitrogen). Thus, the tether 400 may be very stiff due to the high-pressure gas flowing through it. The wheels 390 may be in contact with an interior wall the pipe 900 when expanded in the first configuration. Using simulated friction from the force of the wheels 390 on the wall(s) of the pipe 900, the support robot 300 may overcome its own weight and opposing forces such as those from the weight and stiffness of the tether 400.

One or more modules of the support robot 300 may include a material storage compartment 380 for the feedstock material. In the case of a CSAM, the feedstock material may be metallic powder as discussed herein. In some embodiments, the support robot 300 may carry the feedstock material onboard when launched into the pipeline from the pipeline entrance, and the support robot 300 may travel to the fabrication robot 200 and unload feedstock material into the material storage compartment 280 of the fabrication robot 200, which may then be supplied to the feeder 270.

During a fabrication process, additional feedstock material required for the fabrication process may be obtained by the support robot 300 by traveling back to the entrance of the pipe 900 or location of the feedstock material. There, an operator may load the feedstock material into the support robot 300. Alternatively, in the case where the support robot 300 is launched into a live main pipeline or another potentially hazardous conduit, the support robot 300 may be connected to a port on a launch tube to receive its feedstock material supply.

The feedstock material may be provided into the material storage compartment 380 of the support robot 300. In embodiments where the support robot 300 includes more than one support robot module, the feedstock material may be transferred from one support robot module to subsequent robot modules so that each support robot module has feedstock material within its respective material storage compartment 380.

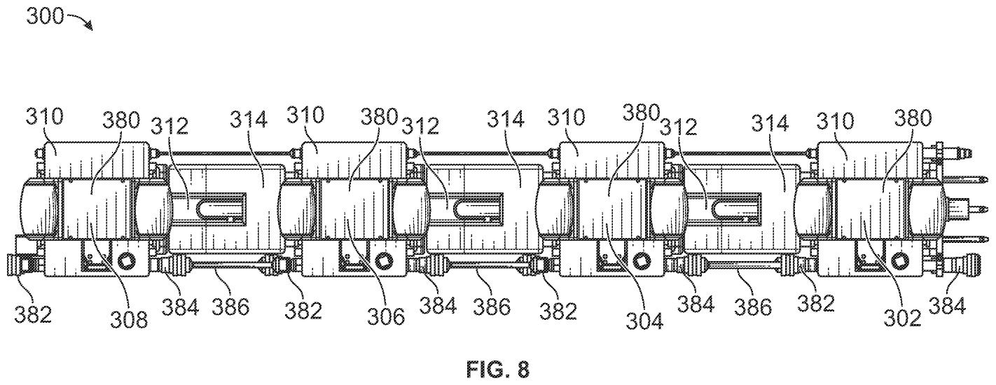

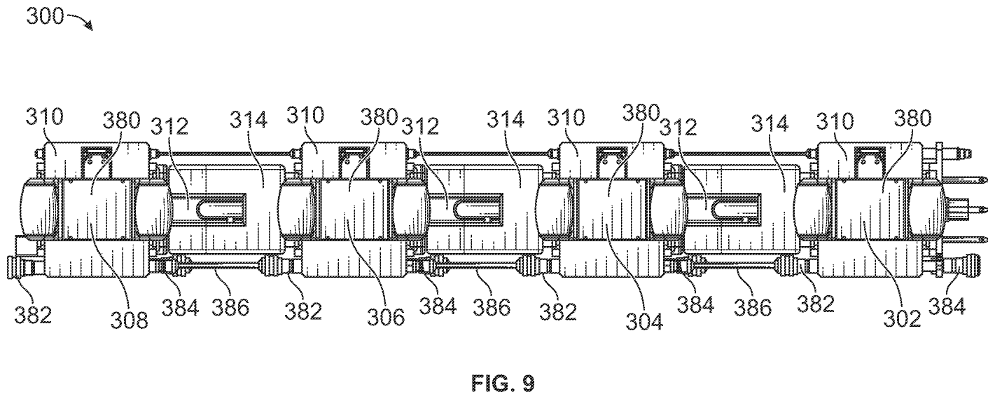

As shown in FIGS. 8 and 9, each of the support robot modules of the support robot 300 may include a first material port 382 and a second material port 384 disposed on opposing sides of the robot 300. The first material port 382 and the second material port 384 each may be defined by an opening that can accept the feedstock material from either another support robot module or externally from, for example, the launch tube or the operator. The second material port 384 of one support robot module may be connected to the first material port 382 of another support robot module through a conduit 386. Moreover, a frontmost support robot module (such as the first support robot module 302 as illustrated in FIG. 6) may have its second material port 384 coupled with the material port 282 of the fabrication robot 200 to facilitate the transfer of the feedstock material from the support robot 300 to the fabrication robot 200.

Alternatively, in other embodiments, feedstock material may be conveyed through sealed cartridges that may be moved from one support robot module to the next, and onto the fabrication robot 200. In some embodiments, all support robot modules and all fabrication robot modules are provided with cartridges. Feedstock material or cartridges may be moved through either vacuum, pneumatics, electrical motor, or other forms of actuation. Empty cartridges may be returned from the fabrication robot 200 to the support robot 300 and then to the launch tube or operator for removal and refilling.

The support robot 300 may further include a sensor module 330 configured to detect an environment of the support robot 300. For example, the sensor module 330 may be a camera, a lidar, a proximity sensor, or other appropriate sensors. The sensor module 330 may be coupled to the second circuit board 320 to provide feedback to the processor. For example, the sensor module 330 may be configured to detect a distance between the support robot 300 and the fabrication robot 200. Moreover, the sensor module 330 may be configured to detect whether a path in front of the support robot 300 is free of obstacles or the like.

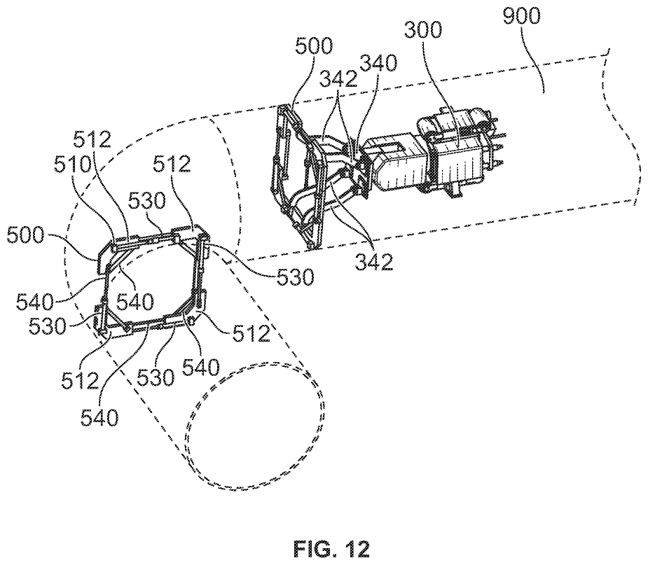

In addition to a first subsystem for conveying feedstock material, the support robot 300 may also include a second subsystem for tether management. Referring to FIG. 12, the support robot 300 may include an installation module 340 protruding from the support robot 300 and designed to install one or more tether management rings 500. The tether management ring 500 may be installed adjacent to or in contact with an interior surface the pipe 900.

The installation module 340 may include one or more actuating arms 342 extending outwardly therefrom for carrying and installing the tether management ring 500. The actuating arms 342 may be controllable and may be configured to operate over a range of different movements. For example, the actuating arms 342 may be configured to retract the tether management ring 500 or expand the tether management ring 500. The installation module 340 may also include an actuator (not shown) and a ring support (not shown) for the mechanical support and installation of the tether management ring 500. During transport, the tether management ring 500 may be stored along the periphery of each module of the support robot 300. Alternatively, the tether management ring 500 may be stored inside a compartment within each module of the support robot 300.

FIG. 12 illustrates a single module of the support robot 300 carrying the tether management ring 500. In this illustrated embodiment, the tether management ring 500 may include a square frame 510. The frame 510 may be provided in multiple frame pieces 512 that are connected through pins that slide in holes of each frame pieces 512. Although four frame pieces 512 are illustrated in FIG. 12, the tether management ring 500 may include more or less frame pieces 512 using the same principles disclosed herein. In some embodiments, the tether management ring 500 may be provided as an integral one-piece construction.

The tether management ring 500 may further include pistons 530 that may be actuated. The pistons 530 may be actuated simultaneously through a common fitting. Gas, such as nitrogen or ambient gas, may be used to actuate the pistons 530, though other gas or liquid may also be used. The actuation of the pistons 530 may expand the frame pieces 512 apart from each other until the frame pieces 512 are resisted by the wall of the pipe 900 from expanding any further. The tether management ring 500 may include a non-return valve to prevent gas from escaping the pistons 530, thus locking the frame pieces 512 in place. In one specific implementation, the tether management ring 500 may be carried by the support robot 300 through a section of the pipe 900 in a retracted configuration and then be extended to an expanded configuration for the installation.

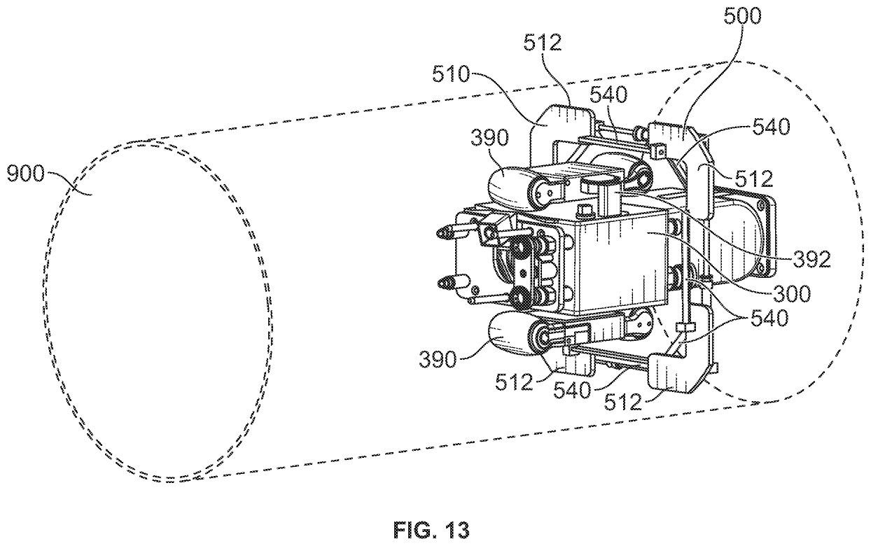

The tether management ring 500 may further include one or more tether rollers 540 disposed in an angular orientation and extending from the inside edges of the frame 510. Eight tether rollers 540 are illustrated in FIGS. 12 and 13 forming an octagonal pattern, though more or fewer tether rollers 540 may also be used and are contemplated. The tether rollers 540 may partially or fully cover an inner circumference of the pipe 900 so as to provide a continuous rolling surface for the tether 400.

In some embodiments, one or more tether management rings 500 may be installed at bends of the pipe 900, thus reducing reduce the drag created by the tether 400. For example, FIG. 12 illustrates two tether management rings 500 installed on both ends of a 90-degree swept bend. Such an arrangement across the bend may minimize drag introduced by the tether 400 at the bends.

Referring to FIG. 13, the tether management ring 500 may be sized to occupy only a small portion of a cross-section of the pipe 900 when fully expanded, enabling the support robot 300 to pass through the frame 510 when the telescopic mechanism 392 carrying the wheels 390 are collapsed. Thus, the support robot 300 may travel back and forth between the fabrication robot 200 and the entrance of the pipe 900 to deliver the feedstock material. Additionally, the support robot 300 may be configured to transport additional items such as empty cartridges or waste material from the manufacturing process that does not get deposited onto the pipe 900. Such undeposited material on the pipe 900 may be retrieved by either the fabrication robot 200 or the support robot 300.

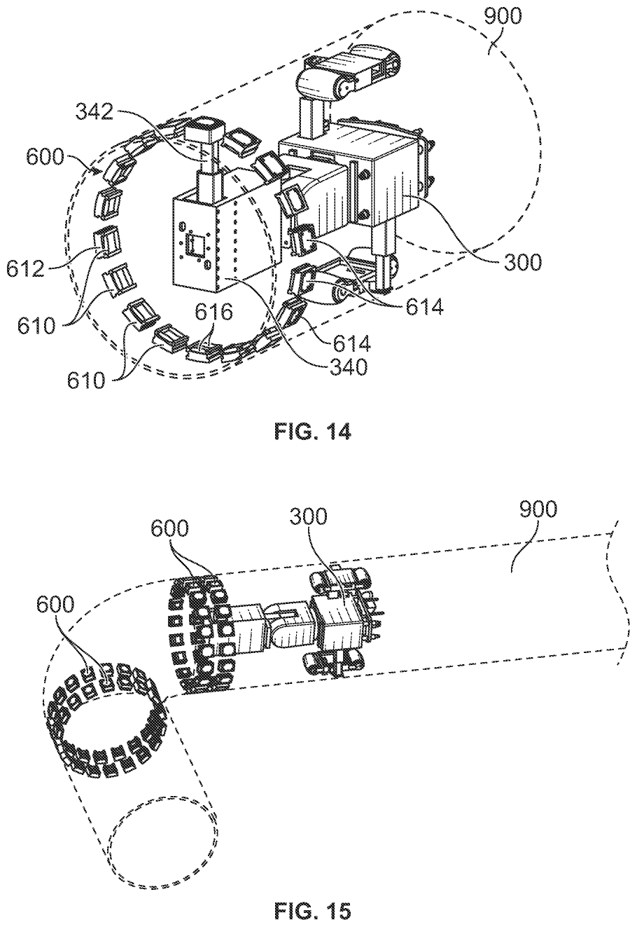

FIGS. 14 and 15 illustrate another embodiment of a tether management ring 600. Here, the tether management ring 600 may include a plurality of ring segments 610. Each of the ring segments 610 may include a ring segment body 612, one or more magnets 614, and one or more tether rollers 616. In such embodiment, the actuating arm 342 of the installation module 340 may be telescopic and rotatable to install each ring segment 610 onto the pipe 900 or to remove the ring segments 610 from the pipe 900.

Each ring segment 610 may be placed along the circumference of the inner wall of the pipe 900 such that the ring segments 610 form the tether management ring 600 with the ring segments 610 when placed adjacent to each other at a same axial location. In some embodiments, the full circumference of the pipe 900 may be covered with the ring segments 610. In other embodiments, it may not be necessary to cover a portion of the pipe 900 (such as the top 180-degree arc) since the tether 400 may never travel above the 3 o'clock and 9 o'clock positions (e.g., adjacent a top surface of the pipe) due to its weight and constraining forces of gravity.

The tether rollers 616 facing the center of the pipe 900 may serve as low-friction surfaces for the tether 400 as the fabrication robot 200 moves in the pipe 900. The low-friction contact may minimize the drag on the tether 400, which may enable the fabrication robot 200 to travel through multiple bends. Magnets 614 of the ring segments 610 may allow the ring segments 610 to stay adhered to the pipe 900 when subjected to forces such as those imparted by the moving tether 400 or from the flow of gas or liquid in the pipe 900.

Referring to FIG. 15, the tether management ring 600 may be installed at a beginning and an end of a bend of the pipe 900. While two tether management rings 600 are shown on either side of the bend, more or less tether management rings 600 may also be used.

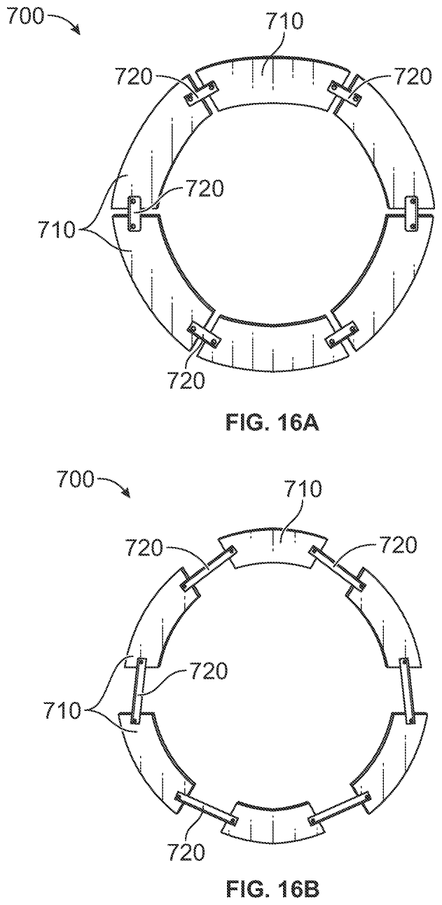

FIGS. 16A and 16B illustrate yet another embodiment of a tether management ring 700. The tether management ring 700 can include a frame 710 provided in the form of a number of frame segments 712. Six frame segments are illustrated in FIGS. 16A and 16B, although another number of frame segments 712 may also be used.

The frame segments 712 may be joined together via linkages 720 such that each frame segment 712 may be collapsed towards and expanded away from one other. The linkages 720 may have indentations or grooves along their length to allow for ratcheting action to occur as the frame segments 712 expand outwards to lock each frame segment 712 position relative to each other.

As shown in FIG. 16B, in some embodiments, the linkages 720 may be provided in the form of a spring and cable system that may be used in between the frame segments 712 to lock and to achieve relative motion between the frame segments 712. The springs may expand each frame segment 712 outward until the frame segments 712 press against the inner wall of the pipe 900. A locking pin and cable to actuate the pin may be used to control the expansion and collapse of the tether management ring 700. In some embodiments, the support robot 300 may actuate the locking pin through an end effector. The tether management ring 700 may include one or more tether rollers (not shown) to serve as contact surfaces with the tether 400.

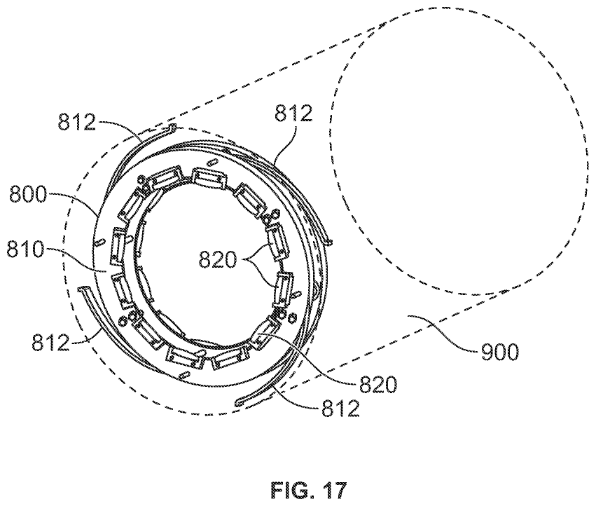

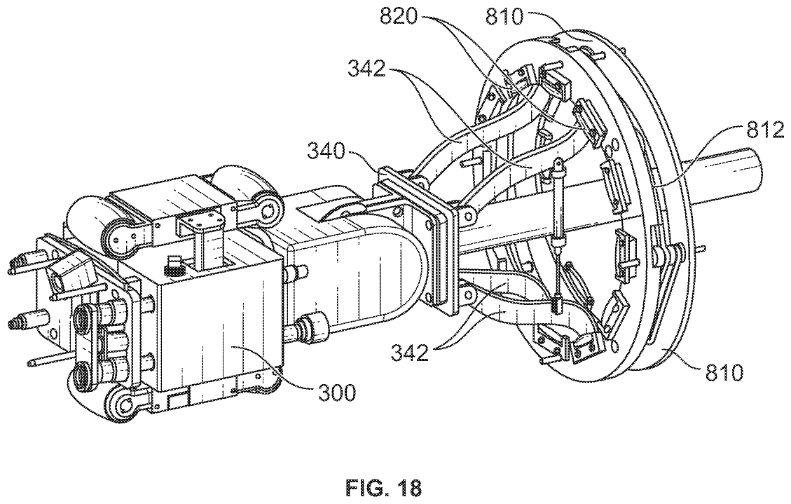

FIGS. 17 and 18 illustrate a further embodiment of a tether management ring 800. The tether management ring 800 is provided in the form of a single-piece frame 810 with tether rollers 820 extending along the inside of the single-piece frame 810. The tether management ring 800 may be installed by the support robot 300 onto the pipe 900 via one or more actuating arms 342. Four actuating arms 342 are illustrated in FIG. 18, although the support robot 300 may include more or less actuating arms 342. The actuating arms 342 may provide a gripper action that allows the support robot 300 to grab the tether management ring 800 and place the tether management ring 800 in a desired position in the pipe 900, followed by releasing the tether management ring 800 at the desired position.

The single-piece frame 810 may include one or more legs 812 disposed at a periphery of the tether management ring 800 that are designed to expand outward and away from the single-piece frame 810. The legs 812 may include springs or a belt and pulley system to provide sufficient frictional forces that prevent the tether management ring 800 from moving in the pipe 900 once the tether management ring 800 is placed in its position. Even though four legs 812 are illustrated in FIGS. 17 and 18, any number of legs 812 may be employed to provide the adequate friction value.

In additional embodiments, the subsystems performed by the support robot 300 may be separated and may be performed by separate robots. For example, in some embodiments, the support robot 300 may be configured to provide the material conveyance function, while another robot may be configured to provide the tether management function such as installing tether management rings. In some further embodiments, tether management rings may be installed by the fabrication robot 200. Likewise, in some embodiments, more than one support robot 300 may be provided, with each performing both the material conveyance function and the tether management function. Such variations are within the scope of this disclosure.

As can be appreciated, in the additive manufacturing system 100, the fabrication robot 200 may continuously fabricate within the pipe 900, while the support robot 300 may continuously provide feedstock material to the fabrication robot 200 to ensure the continuous fabrication (or substantially continuous fabrication) with minimal disturbances or interruptions.

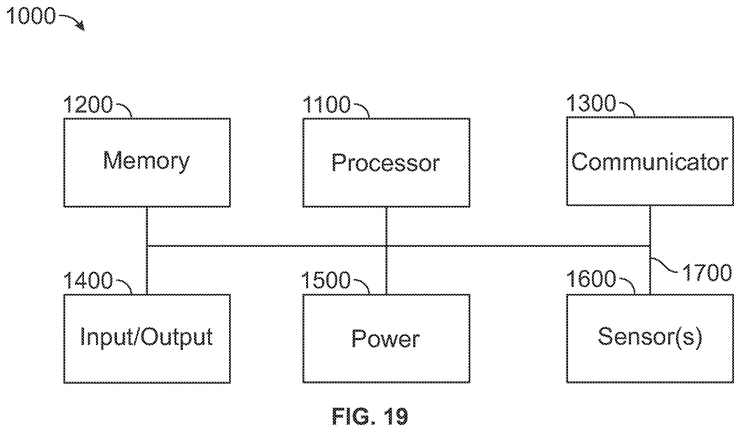

Referring to FIG. 19, a circuit board 1000 may include a processor 1100, a memory 1200, a communicator 1300, an input/output (I/O) 1400, a power source 1500, and one or more sensors 1600. Components within the circuit board 1000 may be connected to one another through one or more connections such as a bus 1700. One or more circuit boards 1000 may be provided to the fabrication robot 200 and/or the support robot 300.

The processor 1100 may be a controller, a microcontroller, a central processing unit (CPU), or other suitable processing units known in the art. The processor 1100 may be configured to execute programs, software, or instructions stored on the memory 1200.

The memory 1200 may be a non-transitory computer-readable media (CRM), a memory device such as a hard drive, a random-access memory (RAM), or other suitable memories known in the art.

The communicator 1300 may be provided in the form of a receiver, a transmitter, and/or a transceiver. The communicator 1300 may be compatible with one or more communication protocols, such as Bluetooth, Wi-Fi, cellular, and/or hardwire communication.

The I/O 1400 may be provided in the form of an input port, an output port, and/or a combined I/O port. The I/O 1400 may accept signals from an external source and output signals to the external source. Alternatively or additionally, the I/O 1400 may include one or more indicators. For example, the I/O 1400 may include one or more visual indicators (such as lights, displays, lasers, or the like) and/or one or more audio indicators (such as speakers).

The power source 1500 may be provided in the form of an internal power source built-in to the circuit board 1000. Alternatively or additionally, the power source 1500 may be provided as a port for accepting external power. For example, the power source 1500 may be adapted to accept batteries, or may be in electrical communication with a power feed from the tether 400 or other source.

In some embodiments, the sensors 1600 may be integrated with the circuit board 1000. In other embodiments, the sensors 1600 may be components external of the circuit board 1000 that may be connected to the circuit board 1000 through one or more connections.

The circuit board 1000 may be adopted for use as the first circuit board 220 for the fabrication robot 200, and/or as the second circuit board 320 for the support robot 300. As can be appreciated, when the circuit board 1000 is adopted for use as the first circuit board 220 for the fabrication robot 200 or as the second circuit board 320 for the support robot 300, some components of the circuit board 1000 may be omitted. Likewise, additional components may be connected to the circuit board 1000 and are within the spirit of this disclosure.

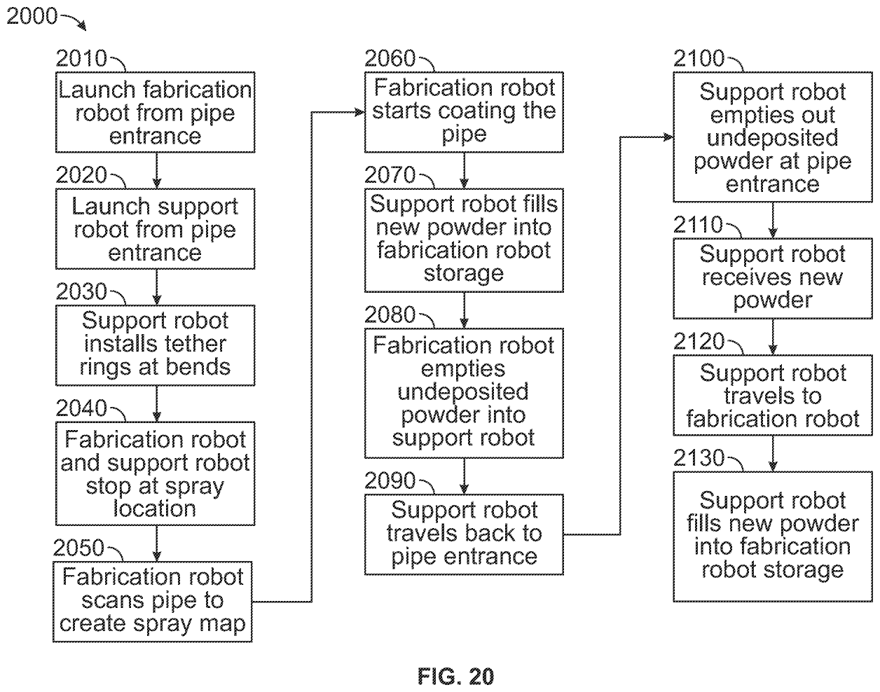

FIG. 20 illustrates a process 2000 for controlling the additive manufacturing system 100 according to an embodiment. At step 2010, the fabrication robot 200 may be launched or otherwise provided into the pipe 900 from an entrance to the pipe 900 or other opening.

At step 2020, the support robot 300 may be launched into the pipe 900 from the entrance to the pipe 900 or other opening. As explained above, the tether 400 to the fabrication robot 200 may be inserted through the opening 316 of the support robot 300. In this way, the support robot 300 may travel along the tether 400 within a length of the pipe 900.

At step 2030, the support robot 300 may be configured to install one or more tether management rings (such as the tether management ring 500, 600, 700, or 800) at one or more bends within the pipe 900 (or other locations). For example, the sensor module 330 of the support robot 300 may detect a bend within the pipe 900. The support robot 300 may determine that one or more tether management rings should be installed and determine the appropriate positions or orientation for such installation. Alternatively, the determination of whether to install a tether management ring may be made by an operator remotely controlling and/or monitoring the support robot 300. In further embodiments, the sensor module 225 of the fabrication robot 200 may detect a bend within the pipe 900 and inform the support robot 300 that one or more tether management rings should be installed.

If the pipe 900 does not include any bends, step 2030 may be omitted. Likewise, if several bends exist within the pipe 900, step 2030 may be repeated as necessary. Moreover, the support robot 300 may be configured to return to the entrance of the pipe 900 to receive additional tether management rings if the pipe 900 includes multiple bends that exceed a number of tether management rings that the support robot 300 is able to transport at one time.

At step 2040, the fabrication robot 200 and the support robot 300 may respectively travel to a repair/spray location within the pipe 900 and stop at an appropriate location adjacent the location. The spray location may be determined by the sensor module 225 onboard the fabrication robot 200. Alternatively or additionally, the spray location may be predetermined before launching the additive manufacturing system 100.

At step 2050, the fabrication robot 200 may scan the pipe 900 to create a spray map. In some embodiments, the sensor module 225 may be configured to scan an interior wall of the pipe 900 to determine one or more precise locations where fabrication may be needed (e.g., a portion of the pipe 900 that needs repairing or rehabilitating). The sensor module 225 may convey the scan to the processor on the first circuit board 220 (or any other circuit board), which may create the scan map using the data from the sensor module 225.

At step 2060, the fabrication robot 200 may begin a fabrication process to create an additive layer within the pipe 900 by engaging appropriate components to begin coating the pipe 900. For example, the fabrication robot 200 may activate the heater 260, the nozzle 240, and the applicator 250. The heater 260 may heat feedstock material to a desired temperature such that the material can be applied and sprayed by the applicator 250 and the nozzle 240.

At step 2070, as the fabrication robot 200 consumes feedstock material as it performs the fabrication process, the support robot 300 may activate its material conveyance subsystem to convey additional feedstock material into the material storage compartment 280 of the fabrication robot 200. For example, the second material port 384 of the support robot 300 may engage and couple with the material port 282 of the fabrication robot 200 to convey the feedstock material.

In some embodiments, the fabrication robot 200 may be configured to determine a fill level within its material storage compartment 280 and inform the support robot 300 accordingly. For example, the fabrication robot 200 may periodically or continuously inform the support robot 300 of its fill level, or the fabrication robot 200 may send a signal to the support robot 300 when the fill level of the material storage compartment 280 is below a threshold (such as 50% fill level or 25% fill level).

At step 2080, the fabrication robot 200 may empty undeposited material into the support robot 300. This can similarly be achieved through a connection formed between the fabrication robot 200 and the support robot 300, such as with the second material port 384 of the support robot 300 and the material port 282 of the fabrication robot 200. In some embodiments, step 2080 may be omitted if the fabrication robot 200 is not expected to have undeposited material.

At step 2090, the support robot 300 may travel back to the entrance of the pipe 900. Positioning of the support robot 300 may be achieved through any appropriate means such as through one or more positioning systems or through sensors or beacons.

At step 2100, the support robot 300 may empty undeposited material. Such undeposited material may be the undeposited material received from the fabrication robot at step 2080, or it may be leftover material remaining in the material storage compartment 380 of the support robot 300, or other waste or leftover material.

At step 2110, the support robot 300 may receive additional feedstock material from an external source. For example, an operator may load the feedstock material into the support robot 300. Alternatively, in the case where the support robot 300 is launched into a live main, the support robot 300 may be connected to a port on a launch tube to receive its feedstock material supply.

At step 2120, the support robot 300 may travel back to the fabrication robot 200. Again, positioning of the support robot 300 may be achieved through any appropriate means such as one or more positioning systems or through sensors or beacons.

At step 2130, the support robot 300 may again engage with the fabrication robot 200 similar to step 2070, and provide the newly received feedstock to the fabrication robot 200 to ensure the fabrication process may be continuous and uninterrupted.

One or more steps within the process 2000 may be repeated until the pipe 900 is repaired or rehabilitated, either fully, or to a satisfactory level. The process 2000 may also be terminated by an operator and by a program, such as a predetermined timer or counter. Once the process 2000 has been completed or terminated, additional steps may be taken to recall support robot 300 and the fabrication robot 200 to the entrance of the pipe 900. Moreover, additional steps may be optionally included in the method such as the step of retracting one or more tether management rings installed during the process 2000. These and other variations are contemplated and are within the spirit of this disclosure.

Specific embodiments of a system and method for additive manufacturing according to the present invention have been described for the purpose of illustrating the manner in which the invention can be made and used. It should be understood that the implementation of other variations and modifications of this invention and its different aspects will be apparent to one skilled in the art, and that this invention is not limited by the specific embodiments described. Features described in one embodiment can be implemented in other embodiments. The subject disclosure is understood to encompass the present invention and any and all modifications, variations, or equivalents that fall within the spirit and scope of the basic underlying principles disclosed and claimed herein.

What is claimed is:

1. A system for additive manufacturing within a pipe, comprising:
a fabrication robot configured to fabricate an additive layer inside the pipe;
a heater configured to heat a material used by the fabrication robot;
a support robot configured to transport the material used by the fabrication robot in manufacturing the additive layer to the fabrication robot, the support robot in communication with the fabrication robot;
at least one wheel for traversing the support robot through the pipe;
a sensor configured to detect a distance between the support robot and the fabrication robot; and
a first material storage compartment for storing the material used to fabricate the additive layer.

2. The system of claim 1, wherein the support robot is configured to refill the first material storage compartment of the fabrication robot.

3. The system of claim 1, wherein the support robot is configured to travel between an entrance of the pipe and the fabrication robot.

4. The system of claim 1, wherein the support robot is further configured to install a tether management ring within the pipe.

5. The system of claim 4, wherein the tether management ring is configured to support a tether coupled to the fabrication robot.

6. The system of claim 4, wherein the support robot is configured to install the tether management ring at a bend of the pipe.

7. The system of claim 4, wherein the tether management ring comprises a first configuration such that the tether management ring is retracted and a second configuration such that the tether management ring is expanded to about an interior surface of the pipe.

8. The system of claim 7, wherein the at least one wheel is a telescopic wheel, and wherein the telescopic wheel can expand when the support robot traverses through the pipe and the telescopic wheel can be retracted when the support robot traverses through the tether management ring.

9. The system of claim 1, wherein the fabrication robot is modular and includes a plurality of fabrication robot modules,
wherein the plurality of fabrication robot modules each comprises the first material storage compartment for storing the material used to fabricate the additive layer, and
wherein a forwardmost fabrication robot module is coupled to a second fabrication module configured to fabricate the additive layer.

10. A method for additive manufacturing within a pipe, comprising:
providing a fabrication robot within the pipe, the fabrication robot including a material storage compartment for storing a material used to fabricate an additive layer within the pipe;
providing a support robot within the pipe, the support robot in communication with the fabrication robot;
determining a distance between the fabrication robot and the support robot with a sensor;
using at least one wheel to traverse the support robot through the pipe;
fabricating the additive layer on an internal surface of the pipe via the fabrication robot;
determining a fill level of the material storage compartment by the fabrication robot;
sending a fill level signal to the support robot when the fill level of the material storage compartment is below a threshold; and
filling the material storage compartment of the fabrication robot via the support robot.

11. The method of claim 10 further comprising:
the support robot traveling between a first location proximal to the fabrication robot to a second location proximal to an entrance of the pipe.

12. The method of claim 11 further comprising:
receiving additional material for fabrication from the first location by the support robot;
traveling to the second location by the support robot; and
the support robot filling the material storage compartment of the fabrication robot with the additional material received.

13. The method of claim 10 further comprising:
installing a tether management ring using the support robot, wherein the tether management ring is configured to support a tether of the fabrication robot.

14. The method of claim 13 further comprising:
retracting a telescopic wheel of the support robot to permit the support robot to travel past the tether management ring; and
extending the telescopic wheel of the support robot after the support robot travel past the tether management ring.

15. The method of claim 10 further comprising:
heating the material used to fabricate the additive layer using the fabrication robot.

16. A system for additive manufacturing within a pipe, the system comprising:
a fabrication robot configured to fabricate an additive layer inside the pipe;
a support robot in communication with the fabrication robot, wherein the support robot is configured to transport material used by the fabrication robot and install a tether management ring, the tether management ring comprising:
a frame;
at least one piston;
a non-return valve; and
a roller on an inside edge of the frame, the roller disposed in an angular orientation and at least partially covers an inner circumference of the pipe, wherein the tether management ring is configured to support a tether coupled to the fabrication robot.

17. The system for additive manufacturing of claim 16, wherein the frame of the tether management ring is expandable to contact a circumference of an interior surface of the pipe.

18. The system for additive manufacturing of claim 17, wherein the frame is provided in the form of multiple frame pieces connected to each other, and the roller is provided between two of the frame pieces.

19. The system for additive manufacturing of claim 16, wherein the frame of the tether management ring is a single-piece construction.

20. The system for additive manufacturing of claim 16, wherein the tether management ring further comprises a plurality of ring segments, wherein each of the plurality of ring segments comprising a ring segment body, a magnet, and the roller.
